(19) United States
(12) Patent Application Publication
(10) Pub. No.: US 2009/0266858 A1
(43) Pub. Date: Oct. 29, 2009

(54) GLOVE BOX DOOR TETHERED UTILITY HOOK

(76) Inventors: Daniel R. Vander Sluis, Plymouth, MI (US); Royce D. Channey, Ann Arbor, MI (US); Gregory A. Nestico, Canton, MI (US)

Correspondence Address: VISTEON/BRINKS HOFER GILSON & LIONE, 524 South Main Street, Suite 200, Ann Arbor, MI, 48104, US

(21) Appl. No.: 12/110,699

(22) Filed: Apr. 28, 2008

(51) Int. Cl. B60R 7/00

(52) U.S. Cl. 224/553; 292/173

(57) ABSTRACT

A glove box and utility hook assembly for a motor vehicle. The assembly includes a tether having one end secured to a hook member and another end secured to a portion defining a glove box, such that the hook member is moveable between a stowed position located within the glove box and a use position located outside of the glove box. The hook member includes a lip portion for retaining and suspending items within a vehicle.

### BACKGROUND

1. Field of the Invention

The present invention generally relates to utility hooks. More particularly, the invention relates to a utility hook for the occupant compartment of a motor vehicle.

2. Description of Related Art

Many vehicles contain utility hooks for temporarily storing or hanging items. Perhaps the most common utility hook is one located above the rear passenger doorway of a vehicle and often used for supporting clothes hangers. Recently, utility hooks have been provided in the glove box area of the instrument panel, generally in front of the front passenger seat. These latter utility hooks are desirable because they provide a vehicle passenger with a convenient location to attach and secure purses, bags, camera cases and the like, which may contain sunglasses, maps or other objects to which ready access may be needed.

Unfortunately, glove box utility hooks have not been sufficiently robust to support various suspended items (a maximum of three pounds in one known construction). In addition, they are often unattractive and detract from the surface that they are mounted on. One such glove box utility hook is disclosed in U.S. Pat. No. 5,975,594. In this construction, the utility hook is integral to the latch assembly of the glove box, providing for a very complex design and a less than desirable outer appearance of the glove box door, of which the utility hook is a part thereof.

### SUMMARY

In overcoming the enumerated drawbacks and other limitations of the related art, the present invention provides an assembly in which a utility hook is tethered to the glove box, more specifically to the interior of the glove box door, such that it is hidden when not in use. In this way, the aesthetic appearance of the glove box door is preserved.

In a preferred embodiment, a tethered utility hook and glove box assembly according to the present invention comprises a utility hook member having a returnly bent first end with an upwardly extending lip portion. Attached to the other end of the hook member is a tether. The opposite end of the tether is attached to an inner surface of the glove box door. In a further preferred embodiment, the inner surface of the glove box door is formed so as to include a receptacle adapted to releasably receive the hook member.

The hook member is movable between a stowed position and a use position. In the stowed position, the lip portion is received in the receptacle and a front face of the utility hook member faces the inner surface of the glove box door. In the use position, the utility hook member is released from the receptacle and the utility hook is extended, via the tether, outside of the glove box and retained in an upright orientation hanging generally toward the floor of the vehicle such that the lip portion extends upwardly. In this use position, a passenger of the vehicle may hang items on the hook member, generally over the upwardly extending lip portion.

The overall length of the tethered utility hook (tether and hook member) is influenced by vehicle safety parameters and predetermined so as to position the hook member, when in the use position, in a location where the first end of the hook member will avoid contact with a passenger's knees during a vehicle crash. Accordingly, when in the use position, it is preferred that the hook member is positioned on the outside the glove box door at a location different from the prescribed knee impact zone during a vehicle crash, thereby preventing injury to a passenger in the front passenger side seat of the vehicle.

The overall length also defines where the receptacle is located along the inner surface of the glove box door. In order for the upwardly extending lip portion of the utility hook member to properly engage in the receptacle, the receptacle is placed a distance from the edge of the glove box door (where the one end of the tether is attached). This prevents bulging of the tether in a situation where the distance between the attachment site of the tether and the receptacle is significantly shorter than the overall length, which may effectively interfere with the closing of the glove box door.

The hook member is preferably made from a low modulus plastic, such as polypropylene or similar material. Accordingly, the utility hook member may be designed to be collapsible itself so that the utility hook does not impede safety performance.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a tethered utility hook and glove box door assembly, in accordance with the present invention, shown in the use position with the glove box door being closed;

FIG. 2 is a perspective view of the tethered utility hook and glove box assembly shown with the glove box door being in an open position;

FIG. 3 is a perspective view of tethered utility hook and glove box assembly showing the tethered utility hook being moved from a use position to a stowed position; and

FIG. 4 is an enlarged perspective view of the portion within circle 4 in FIG. 3, showing the tethered utility hook and glove box assembly with the utility hook in a stowed position.

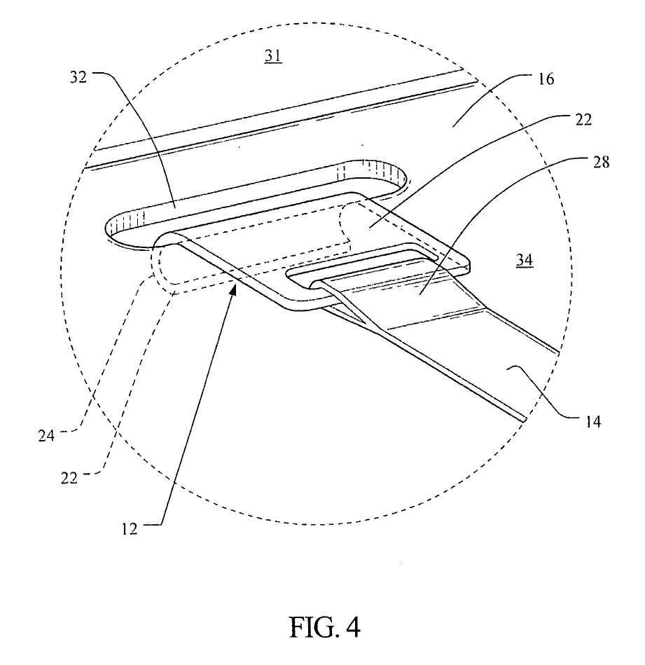

### DETAILED DESCRIPTION

Referring now to the drawings, a tethered utility hook and glove box assembly is illustrated therein and designated generally at 10. The assembly 10 includes a hook member 12 attached to a tether 14, which is in turn connected to a glove box door 16 of an instrument panel 18 located within the occupant compartment of a motor vehicle, such as an automobile, light duty truck, etc. The hook member 12 is designed to retain and support suspended items, such as purses, bags, phones, cameras, etc.

The hook member 12 is generally of a J-shaped configuration and includes a shank 20 and a terminal end 22. This shank 20 is connected to the terminal end 22 by a reverse bend 24. Thus, the terminal end 22 is spaced apart from and extends in an opposite direction of the shank 20 by virtue of the reverse bend 24. In this manner, the terminal end 22 operates as a lip portion for the hook member 12.

The shank is secured at its free end to the tether 14. To achieve this, the shank 20 may be provided with an opening 26 through which one end of the tether 14 is extended and sewn or otherwise joined back upon itself to hook member 12 in an end loop 28 of the tether 14. The opposing end 29 of the tether 14 is fixedly secured through the glove box door 16. Preferably, the tether 14 is attached to the glove box door 16 immediately inside the edge 30 of the glove box door 16. In this manner, when the utility is in its stored position, as further described below, and the glove box door 16 is closed, the tether 14 is not visible from the exterior of the glove box door 16 or instrument panel 18. The tether 16 may be secured to the glove box door 16 in any convenient manner, including use of screws, bolts, or other fasteners or adhesively bonding or welding of the tether 14 to an appropriate structure such as a reinforced frame, member or substrate (not shown) of the glove box door 16.

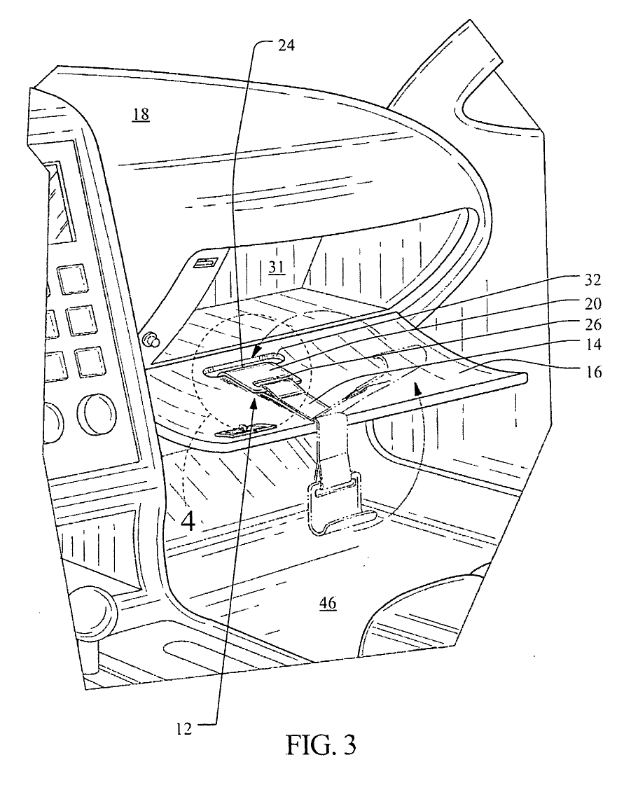

Referring now to FIG. 3, the hook member 12 is shown therein being moved from its in-use position to its stowed positions. Obviously, in its deployed position, the utility hook member 12 hangs via the tether 14 in a position on the exterior of the glove box door 16 so as to accessible from the occupant compartment of the vehicle. In its stowed position, the utility hook member is concealed by the glove box door 16 within the glove box compartment 31 itself. To retain the hook member 12 in this stowed position, a recess 32 is formed on an interior surface 34 of the glove box door 16. The recess 32 is shaped so as to receive at least a portion of the hook member 12 therein. The recess 32 and the interior surface 34 of the glove box door 16 includes a retaining feature 36, which engages the terminal end 22 of the hook member 12. The retaining feature 36, may take various forms including an undercut of the recess into which the terminal end 22 of the hook member 12 is received and retained or bosses or biasing elements formed or located on interior surfaces of the recess 32 so as to engage the utility hook member 12 in a snap or press fit engagement. Additionally, a portion of the recess 32 may extend to the edge 30 of the glove box door 16 such that the tether 14 and hook member 12 are received therein and retained in a flush manner with the interior surface 34. In this way, items being stored or located within the compartment of the glove box can be received therein without being impeded by the tether 14 or the hook member 12. Additionally, the location of the retaining feature 36 and recess 32 along the interior surface 34 of the glove box door 16 is preferably such that the tether 14 is substantially fully extended from its attachment point 29 to the glove box door 16. This prevents unnecessary bulging of the tether 14 in the stowed position.

In the preferred embodiment, the inner structure of the glove box door is reinforced such that the tethered utility hook 10 is sufficiently capable of supporting large loads when in the use position 42. As depicted in FIG. 3, the tethered utility hook 12 is movable between a use position (showed in phantom) and a stowed position, and vice versa. When a passenger of the vehicle desires to suspend an item from the tethered utility hook 10, the tethered utility hook 10 must be disengaged from the retaining feature of receptacle 32 of the glove box door 16. Specifically, the terminal end or lip portion 22 of the hook member 12 must be released from the receptacle 36. The flexible tether 14 allows a passenger to easily swing the tethered utility hook 10 from its stowed position 38, over the edge 30 of the glove box door 16 such that the tethered utility hook 10 hangs generally in front of the glove box door 16. The glove box door 16 may then be closed with the tethered utility hook 12 located outside of the glove box compartment 31.

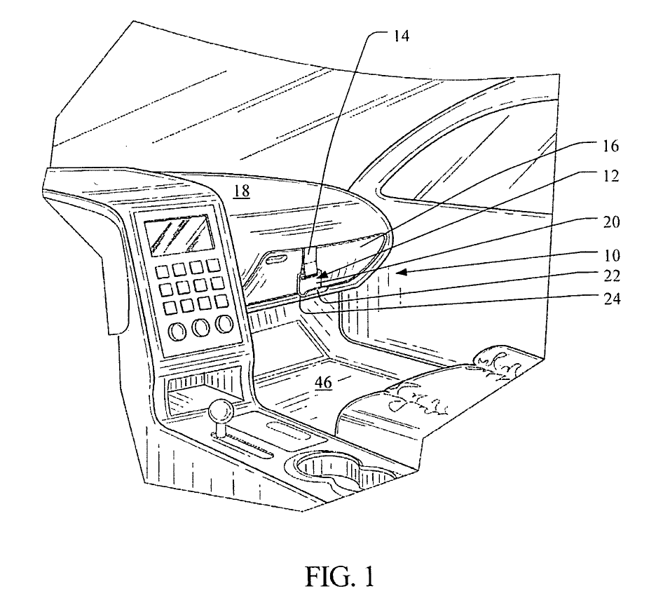

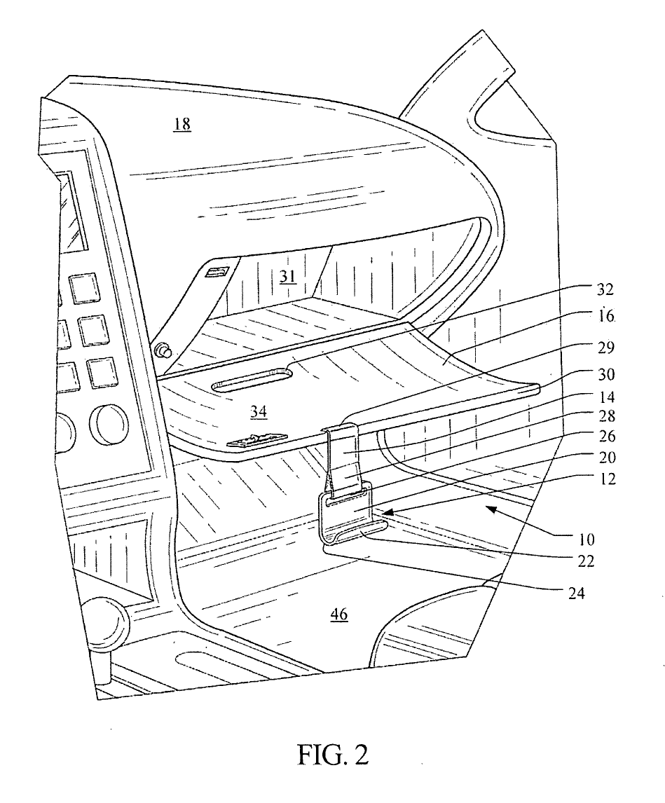

FIGS. 1 and 2 illustrate the tethered utility hook 10 in the use position. In the use position, the tethered utility hook 10 generally hangs in a vertical orientation, generally perpendicular to the floor vehicle floor 46. In this position, the terminal end or lip portion 22 of the hook member 12 faces the interior compartment of the vehicle. As previously noted, preferably the overall length of the tethered utility hook 10 positions the hook member 12 above the prescribed impact zone of the knee bolster, thereby avoiding injury to a front seat passenger during a crash.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I claim:

1. A glove box and utility hook assembly for a motor vehicle, the assembly comprising:
a hook member having a shank, a return bend portion and a lip portion;
a tether having a first end secured to the hook member and a second end secured to a portion a glove box; and
the hook member being movable between a stowed position and a used position, in the use position the hook member being located within a compartment defined by the glove box, and in the use position the hook member being located outside of the glove box.

2. The assembly of claim 1 wherein the lip portion of the hook member faces a door of the glove box in the stowed position.

3. The assembly of claim 1, wherein the hook member is positioned generally adjacent a door of the glove box in the use position.

5. The assembly of claim 4, wherein lip portion of the hook member faces away from the glove box in the use position.

6. The assembly of claim 1, further comprising a receptacle defined by portions of the glove box, the receptacle configured to receive at least a portion of the hook member therein.

7. The assembly of claim 6, wherein the receptacle defines a slot.

8. The assembly of claim 6, wherein the receptacle is defined in a door portion of the glove box.

9. The assembly of claim 1 wherein the tether is secured to a door of the glove box.

10. The assembly of claim 1 wherein the tether is secured along an edge of a door of the glove box.

11. The assembly of claim 1 wherein the tether is flexible.

12. The assembly of claim 1 wherein the hook member is rigid.
